(19) United States
(12) Patent Application Publication
(10) Pub. No.: US 2013/0000767 A1
(43) Pub. Date: Jan. 3, 2013

(54) METHOD OF MANUFACTURING RUBBER HOSE, RUBBER HOSE AND RUBBER HOSE WITH END CLAMP

(75) Inventors: Takafumi NONAKA, Hitachi (JP); Tomonori SAITO, Hitachi (JP); Tsutomu KANNO, Hitachi (JP); Tomonori SHIBATA, Hitachi (JP); Shunsuke TODA, Hitachi (JP)

(73) Assignee: Hitachi Cable, Ltd., Tokyo (JP)

(21) Appl. No.: 13/536,805

(22) Filed: Jun. 28, 2012

(30) Foreign Application Priority Data
Jul. 1, 2011 (JP) 2011-147314
Mar. 26, 2012 (JP) 2012-068577

(51) Int. Cl. F16L 11/12; B32B 37/12; B32B 37/02; F16L 11/02; F16L 3/00

(52) U.S. Cl. 138/106; 138/126; 156/123

(57) ABSTRACT

A method of manufacturing a rubber hose that includes an inner rubber tube having a hollow portion, first and second braided layers formed by braiding strands, and an outer rubber tube. The method includes forming a laminated structure by sequentially forming the first braided layer on the inner rubber tube, a thermoplastic resin layer including a thermoplastic resin on the first braided layer, the second braided layer on the thermoplastic resin layer and the outer rubber tube on the second braided layer, vulcanizing the inner rubber tube and the outer rubber tube and softening the thermoplastic resin layer by heating the laminated structure to not lower than a softening temperature of the thermoplastic resin layer, and integrating the first and second braided layers by softening the thermoplastic resin layer and then solidifying the soft thermoplastic resin penetrated into mesh openings formed between the strands.

The present application is based on Japanese patent application Nos. 2011-147314 and 2012-068577 filed on Jul. 1, 2011 and Mar. 26, 2012, respectively, the entire contents of which are incorporated herein by reference.

### BACKGROUND OF THE INVENTION

1. Field of the Invention

The invention relates to a rubber hose and a method of manufacturing the rubber hose, in particular, to a method of manufacturing a rubber hose suitable as a vehicle brake hose used in a brake system of a vehicle such as car or motorcycle, etc., to convey high-pressure fluid or to transfer pressure, and the rubber hose.

2. Description of the Related Art

A conventional rubber hose is provided with an inner rubber tube, double braided reinforcing layers provided on the outer side of the inner rubber tube and an outer rubber tube formed on the outer side of the double braided reinforcing layers (see Japanese patents No. 4304922 and No. 3271752).

A brake hose described in Japanese patent No. 4304922 has a first braided fiber reinforcing layer, a middle rubber layer formed on the outer side of the first braided fiber reinforcing layer and a second braided fiber reinforcing layer formed on the outer side of the middle rubber layer. The middle rubber layer is provided to prevent abrasion between the first and second braided fiber reinforcing layers and thereby to improve durability of the rubber hose.

A brake hose described in Japanese patent No. 3271752 has a first braided fiber reinforcing layer provided on the outer side of an inner rubber tube, a second braided fiber reinforcing layer formed on the outer side of the first braided fiber reinforcing layer and a cured layer in which braids of the first braided fiber reinforcing layer are integrally cured.

In a method of manufacturing a brake hose described in Japanese patent No. 3271752, the cured layer is formed through an impregnation step and an extraction step. These steps are generally carried out in a continuous flow production by feeding a long material hose at a constant speed. The impregnation step is a process in which a material hose having the first braided fiber reinforcing layer formed thereon is dipped into a thermoplastic resin solution in an impregnating bath to impregnate the first braided fiber reinforcing layer with the thermoplastic resin solution. The extraction step is a process in which the thermoplastic resin solution impregnated into the first braided fiber reinforcing layer is squeezed out. After these steps, the second braided fiber reinforcing layer is formed on an outer periphery of the first braided fiber reinforcing layer.

### SUMMARY OF THE INVENTION

In the brake hose described in Japanese patent No. 4304922, it is difficult to sufficiently prevent abrasion at each mesh opening of the first and second braided fiber reinforcing layers only by providing the middle rubber layer and it is necessary to use a specific chemical fiber having high abrasion resistance for forming the first and second braided fiber reinforcing layers in order to improve abrasion resistance.

Furthermore, in the brake hose described in Japanese patent No. 3271752, the thermoplastic resin solution must be impregnated and extracted in the impregnation step and the extraction step for forming the cured layer. Since it is not desirable to significantly bend the material hose in the continuous flow production, especially in the impregnation step, a long impregnating bath is required in order to pass the material hose therethrough with less bending of the material hose. Meanwhile, the extraction step requires a special apparatus. That is, the method of manufacturing a brake hose described in Japanese patent No. 3271752 has a problem that a manufacturing space is large.

Accordingly, it is an object of the invention to provide a method of manufacturing a rubber hose that allows an improvement of durability by reducing abrasion caused by contact between first and second braided layers and abrasion of the first and second braided layers caused between braids thereof, as well as the rubber hose and the rubber hose with an end clamp.

(1) According to one embodiment of the invention, a method of manufacturing a rubber hose comprising:

an inner rubber tube having a hollow portion;

first and second braided layers formed by braiding strands; and

an outer rubber tube,

comprises:

forming a laminated structure by sequentially forming the first braided layer on an outer periphery of the inner rubber tube, a thermoplastic resin layer comprising a thermoplastic resin on an outer periphery of the first braided layer, the second braided layer on an outer periphery of the thermoplastic resin layer and the outer rubber tube on an outer periphery of the second braided layer;

vulcanizing the inner rubber tube and the outer rubber tube and softening the thermoplastic resin layer by heating the laminated structure to not lower than a softening temperature of the thermoplastic resin layer; and

integrating the first and second braided layers by softening the thermoplastic resin layer and then solidifying the soft thermoplastic resin penetrated into mesh openings formed between the strands.

In the above embodiment (1) of the invention, the following modifications and changes can be made.

(i) The thermoplastic resin layer comprises polyethylene (PE) having a melting point of 90 to 165° C. or polyethylene-polyvinyl acetate copolymer (EVA) having a melting point of 90 to 165° C.

(ii) The thermoplastic resin layer comprises polypropylene (PP) having a melting point of 90 to 165° C.

(iii) The thermoplastic resin layer is formed by winding a strip-shaped thermoplastic resin around the outer periphery of the first braided layer.

(iv) The strand comprises a vinylon fiber.

(v) The first braided layer has a braid density of 3500 to 4400 dtex/mm, and the second braided layer has a braid density of 2700 to 5200 dtex/mm.

(2) According to another embodiment of the invention, a rubber hose comprises:

an inner rubber tube having a hollow portion;

first and second braided layers formed by braiding strands and provided on an outer periphery of the inner rubber tube; and

an outer rubber tube provided on an outer peripheral side of the first and second braided layers,

wherein the first and second braided layers are integrated by solidifying a soft thermoplastic resin penetrated into mesh openings formed between the strands.

In the above embodiment (2) of the invention, the following modifications and changes can be made.

(vi) The rubber hose is adapted to be used as a brake hose for a vehicle, wherein the hollow portion of the inner rubber tube is adapted to circulate a brake fluid for operating a brake of the vehicle therethrough.

(3) According to another embodiment of the invention, a rubber hose an end clamp comprises:

an inner rubber tube having a hollow portion;

first and second braided layers formed by braiding strands and provided on an outer periphery of the inner rubber tube;

an outer rubber tube provided on an outer peripheral side of the first and second braided layers; and

the end clamp crimped at an end portion of the outer rubber tube,

wherein the first and second braided layers are integrated by solidifying a soft thermoplastic resin penetrated into mesh openings formed between the strands.

### EFFECTS OF THE INVENTION

According to one embodiment of the invention, a method of manufacturing a rubber hose can be provided that allows an improvement of durability by reducing abrasion caused by contact between first and second braided layers and abrasion of the first and second braided layers caused between braids thereof, as well as the rubber hose and the rubber hose with an end clamp.

### BRIEF DESCRIPTION OF THE DRAWINGS

Next, the present invention will be explained in more detail in conjunction with appended drawings, wherein:

FIG. 1 is a perspective view showing a configuration of a brake hose in an embodiment of the present invention;

FIGS. 2A to 2C are diagrams illustrating a configuration of a laminated structure in a manufacturing process of the brake hose, wherein FIG. 2A is an overall perspective view and FIGS. 2B and 2C are partial enlarged views of FIG. 2A;

FIGS. 3A to 3F are explanatory diagrams illustrating each stage of the manufacturing process of the brake hose; and

FIG. 4 is a simplified diagram illustrating a cross section of a brake hose with end clamp 100.

### DETAILED DESCRIPTION OF THE PREFERRED EMBODIMENTS

### Embodiment

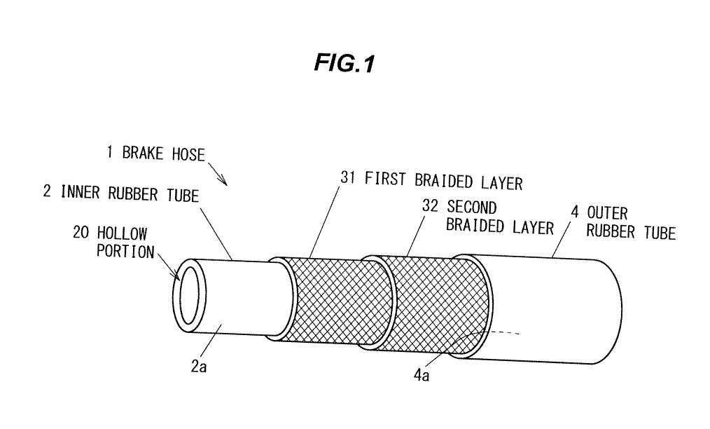

A brake hose as an example of a rubber hose in an embodiment of the invention and a method of manufacturing the same will be described below in reference to FIGS. 1 to 3F.

FIG. 1 is a perspective view showing a configuration of a brake hose in an embodiment of the invention.

A brake hose 1 is mounted on a vehicle such as car or motorcycle, etc., and is used to circulate a brake fluid to activate a brake system for operating a brake of the vehicle. For this type of brake hose, it is necessary to ensure high durability against bending caused by operation of a steering wheel of a vehicle or turning of wheels and against mechanical stress such as vibration, etc., during driving of the vehicle. In addition, it is desired that expansion is as small as possible even when pressure of the brake fluid increases.

As shown in FIG. 1, the brake hose 1 has a cylindrical-shaped inner rubber tube 2 made of rubber, first and second braided layers 31 and 32 formed by braiding strands and provided on an outer periphery of the inner rubber tube 2 and an outer rubber tube 4 provided on an outer peripheral side of the first and second braided layers 31 and 32. The first and second braided layers 31 and 32 are integrated by a below-described thermoplastic resin layer 30.

The inner rubber tube 2 is a tube having a hollow portion 20 thereinside to circulate a brake fluid. In the present embodiment, ethylene-propylene-diene rubber (EPDM) is used as a rubber material constituting the inner rubber tube 2. EPDM is excellent in heat resistance, cold resistance, ozone resistance and weather resistance due to the molecular structure thereof. In addition, EPDM is a low polar polymer and thus has a less risk of corroding components in contact with a brake hose (metal components such as banjo bolt used for connecting the brake hose 1 to a cylinder, etc.).

In addition, a filler, a cross-linking agent, a reinforcing agent, a plasticizer, a processing aid, an activator or an antiscorching agent, etc., can be added to EPDM if necessary. In addition, it is possible to use anti-aging agents and vulcanization-based additives such as a vulcanizing agent, a vulcanization accelerator and a vulcanization aid, etc.

Alternatively, chloroprene rubber (CR), natural rubber (NR), styrene-butadiene rubber (SBR), isobutylene rubber (IIR) and chlorosulphonated polyethylene rubber (CSM), etc., may be used as a rubber material constituting the inner rubber tube 2. Note that, when the rubber hose in the invention is used as a brake hose as is in the present embodiment, natural rubber (NR), styrene-butadiene rubber (SBR) and isobutylene rubber (IIR) are especially suitable as a rubber material constituting the inner rubber tube 2.

The first braided layer 31 is provided so as to be in contact with an outer peripheral surface 2a of the inner rubber tube 2. The second braided layer 32 is provided on an outer peripheral side of the first braided layer 31. In the present embodiment, the first braided layer 31 and the second braided layer 32 are formed by braiding strands of vinylon fiber.

Fibers which can be used as a strand constituting the first braided layer 31 and the second braided layer 32, besides the vinylon fiber, are synthetic fibers such as polyethylene terephthalate (PET) fiber, polyethylene 2,6-naphthalate (PEN) fiber, polybutylene terephthalate fiber, polyacrylate fiber, vinylon fiber, nylon fiber, aramid fiber, acrylic fiber, polyacrylonitrile fiber, polyethylene fiber, polypropylene fiber, polyvinyl chloride-based fiber, polyurethane fiber, polyoxymethylene fiber, polytetrafluoroethylene fiber, polyparaphenylene benzobisoxazole fiber, polyimide fiber or polyphenylene sulfide fiber, chemical fibers such as rayon or novolak, and natural fibers such as cotton or hemp.

The outer rubber tube 4 is provided as the outermost layer of the brake hose 1. A rubber material constituting the outer rubber tube 4 can be the same as the above-mentioned rubber materials used for constituting the inner rubber tube 2. In the present embodiment, EPDM is used as the rubber material constituting the outer rubber tube 4 in the same manner as the inner rubber tube 2.

Method of Manufacturing Brake Hose 1

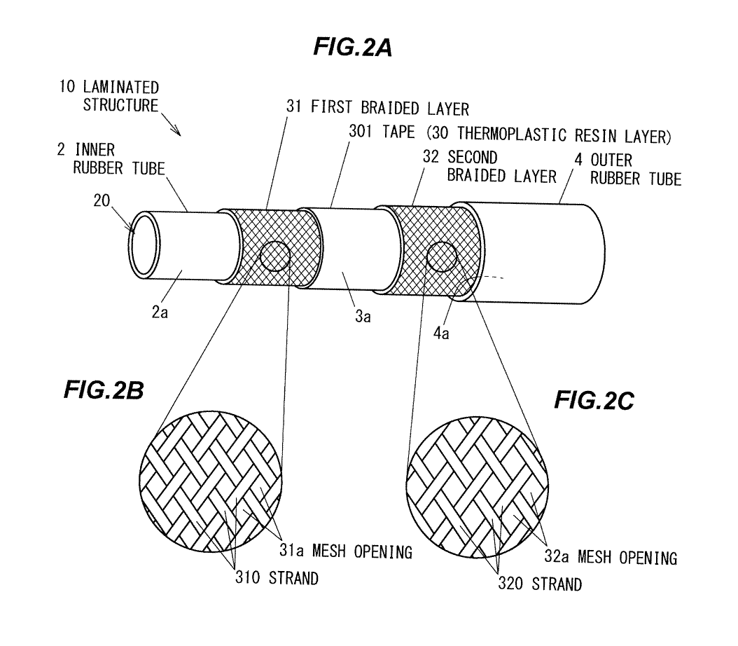

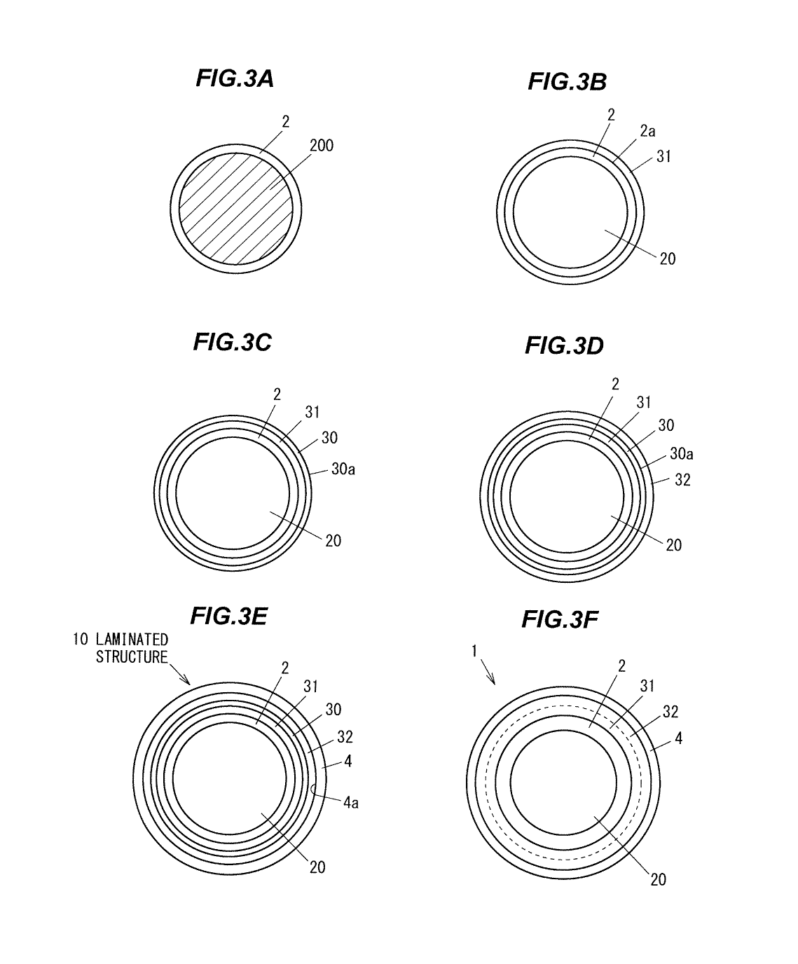

Next, a method of manufacturing the brake hose 1 in the present embodiment will be described in reference to FIGS. 2A to 3F.

FIGS. 2A to 2C show a configuration of a laminated structure 10 composed of the inner rubber tube 2, the first and second braided layers 31 and 32, the thermoplastic resin layer 30 and the outer rubber tube 4 in a manufacturing process of the brake hose 1, wherein FIG. 2A is an overall perspective view and FIGS. 2B and 2C are partial enlarged views of FIG. 2A. FIGS. 3A to 3F are explanatory diagrams illustrating each stage of the manufacturing process of the brake hose 1. Note that, thicknesses of the first braided layer 31, the thermoplastic resin layer 30 and the second braided layer 32 are exaggerated in FIGS. 3B to 3F for the purpose of explanation.

The manufacturing process of the brake hose 1 includes a laminated structure forming step of forming the laminated structure 10, a vulcanization-softening step of vulcanizing the inner rubber tube 2 as well as the outer rubber tube 4 and simultaneously softening the thermoplastic resin layer 30 by heating the laminated structure 10 to not less than a temperature at which the thermoplastic resin layer 30 is softened, and an integrating step of integrating the first and second braided layers 31 and 32 by solidifying the softened thermoplastic resin layer.

Laminated Structure Forming Step

In the laminated structure forming step, the first braided layer 31 is formed on the outer periphery of the inner rubber tube 2, the thermoplastic resin layer 30 is formed on the outer periphery of the first braided layer 31, the second braided layer 32 is formed on the outer periphery of the thermoplastic resin layer 30 and the outer rubber tube 4 is then formed on the outer periphery of the second braided layer 32, thereby forming the laminated structure 10.

To form the inner rubber tube 2, for example as shown in FIG. 3A, a rubber material to be the inner rubber tube 2 is extruded on a non-illustrated mandrel 200 having an outer diameter equivalent to an inner diameter of the inner rubber tube 2.

As shown in FIGS. 2B and 3B, the first braided layer 31 is formed by braiding strands 310 formed of vinylon fiber on the outer peripheral surface 2a of the inner rubber tube 2. As shown in FIG. 2B, the strands 310 are braided in a lattice pattern and a mesh opening 31a is formed between the horizontally and vertically adjacent strands 310. The first braided layer 31 is formed on the outer peripheral surface 2a of the inner rubber tube 2 so as to have a braid density of 3500 to 4400 dtex/mm. The thermoplastic resin softened in the below-described vulcanization-softening step can sufficiently penetrates into the mesh openings 31a of the first braided layer 31 by having such a braid density.

As shown in FIGS. 2A and 3C, the thermoplastic resin layer 30 is formed by longitudinally wrapping a strip-shaped thermoplastic resin tape 301 around the outer periphery of the first braided layer 31. The tape 301 is wrapped to cover the first braided layer 31 without any gap while being in contact with each strand 310 of the first braided layer 31. Alternatively, it is possible to form the thermoplastic resin layer 30 by helically winding the strip-shaped tape 301.

The thermoplastic resin layer 30 (the tape 301) is formed of thermoplastic resin which exhibits fluidity when softened by heat. The thermoplastic resin is preferably any one of polypropylene (PP) having a melting point of 90 to 165° C., polyethylene (PE) having a melting point of 90 to 165° C. and polyethylene-polyvinyl acetate copolymer (EVA) having a melting point of 90 to 165° C. In the present embodiment, polyethylene (PE) is used as the thermoplastic resin. The thickness of the thermoplastic resin layer 30 should be within a range of 0.01 mm to 0.1 mm.

Thermoplastic resins which can be used as a material of the thermoplastic resin layer 30, besides PP, PE and EVA, are, e.g., polyester (PET), polycarbonate (PC), polyvinyl chloride (PVC), polyvinylidene chloride (PVDC), ethylene vinyl alcohol copolymer (EVOH) and moisture proof cellophane, etc.

As shown in FIG. 3D, the second braided layer 32 is formed on the outer periphery of the thermoplastic resin layer 30 so as to be in contact with an outer peripheral surface 30a of the thermoplastic resin layer 30. As shown in FIG. 2C, strands 320 formed of vinylon fiber are braided in a lattice pattern, thereby forming the second braided layer 32. A mesh opening 32a is formed between the horizontally and vertically adjacent strands 320. The second braided layer 32 is formed on the outer peripheral surface 30a of the thermoplastic resin layer 30 so as to have a braid density of 2700 to 5200 dtex/mm. The thermoplastic resin softened in the below-described vulcanization-softening step can sufficiently penetrates into the mesh openings 32a of the second braided layer 32 by having such a braid density.

As shown in FIG. 3E, the outer rubber tube 4 is formed by extruding a rubber material on an outer peripheral surface of the second braided layer 32 so that the entire second braided layer 32 is covered and so that an inner surface 4a of the outer rubber tube 4 is in contact with the second braided layer 32.

Through the above processes, the laminated structure 10 in which the inner rubber tube 2, the first braided layer 31, the thermoplastic resin layer 30, the second braided layer 32 and the outer rubber tube 4 are laminated in this order from the inner side is obtained.

Vulcanization-Softening Step

In the vulcanization-softening step, the laminated structure 10 is heated to vulcanize the inner rubber tube 2 and the outer rubber tube 4 and also to melt the thermoplastic resin layer 30 (the tape 301), and the soft thermoplastic resin as the molten thermoplastic resin layer 30 penetrates into the mesh openings 31a of the first braided layer 31 and the mesh openings 32a of the second braided layer 32. The heating is carried out until reaching a predetermined temperature which is a temperature causing vulcanization reaction of the inner rubber tube 2 and the outer rubber tube 4 (hereinafter, referred to as a vulcanization temperature) and also is not less than the melting point of the tape 301, and then, the predetermined temperature is maintained.

In the present embodiment, the melting point of the solid tape 301 (the thermoplastic resin layer 30) is 100° C. and the vulcanization temperature of the inner rubber tube 2 and the outer rubber tube 4 is 140° C. In other words, the melting point of the tape 301 is lower than the vulcanization temperature of the inner rubber tube 2 and that of the outer rubber tube 4. Therefore, the heating temperature is set to not less than 140° C. Note that, the heating temperature is not changed even in the case of using polypropylene (PP) as a material of the tape 301 since the melting point thereof is 120° C.

When the tape 301 is melted and is transformed into a soft thermoplastic resin in a liquid state, the soft thermoplastic resin flows and penetrates into the mesh openings 31a of the first braided layer 31 and the mesh openings 32a of the second braided layer 32, as shown in FIG. 3F.

Integrating Step

In the integrating step, the soft thermoplastic resin obtained by softening the thermoplastic resin layer 30 and penetrated into the mesh openings 31a of the first braided layer 31 and the mesh openings 32a of the second braided layer 32 in the vulcanization-softening step is solidified to integrate the first braided layer 31 with the second braided layer 32. In more detail, the laminated structure 10 is cooled to not more than the melting point of the thermoplastic resin constituting the tape 301 in a state that the soft thermoplastic resin as the molten tape 301 penetrates into the mesh openings 31a of the first braided layer 31 and the mesh openings 32a of the second braided layer 32. As a result, the soft thermoplastic resin as the molten tape 301 is solidified and the first braided layer 31 is integrated with the second braided layer 32.

Then, the mandrel 200 is removed at the end and the brake hose 1 is obtained.

### Effects of the Embodiment

The present embodiment can have the following functions and effects.

(1) Penetration and solidification of the soft thermoplastic resin as the molten tape 301 in the mesh openings 31a of the first braided layer 31 and the mesh openings 32a of the second braided layer 32 provide strong adhesion between the first braided layer 31 and the second braided layer 32, which allows abrasion between the first braided layer 31 and the second braided layer 32 to be suppressed and abrasion of the first braided layer 31 and the second braided layer 32 caused between the braids thereof to be reduced.

(2) The impregnation step and the extraction step are not required and it is thus possible to downsize a manufacturing facility (to reduce a manufacturing space) and to cut down use of VOC (Volatile Organic Compounds). In addition, since the soft thermoplastic resin as the molten tape 301 is solidified by lowering the temperature, it is possible to carry out the vulcanization-softening step and the integrating step while, e.g., rewinding the brake hose 1 onto a reel.

(3) Since the thermoplastic resin layer 30 is formed by wrapping the tape 301 around the outer periphery of the first braided layer 31, it is possible to easily form the thermoplastic resin layer 30 as compared to the case of using, e.g., a paste thermoplastic resin. In addition, the thickness of the thermoplastic resin layer 30 can be uniform and can be, e.g., 0.01 mm to 0.1 mm while covering the outer periphery of the first braided layer 31 without any gap. The thickness of the thermoplastic resin layer 30 is, e.g., not more than 20% of a thickness of a middle rubber layer in a conventional brake hose and it is thus possible to reduce the thickness and weight of the brake hose 1. In addition, since various materials added to the middle rubber layer of the conventional brake hose, such as a filler, a cross-linking agent, a reinforcing agent, a plasticizer, a processing aid, an activator, an antiscorching agent or an anti-aging agent, etc., are not required for the brake hose 1 in the present embodiment, it is possible to further lighten the weight and to reduce the cost.

(4) Since the vinylon fiber with low expansion characteristics is used as the strand 310 of the first braided layer 31 and the strand 320 and the second braided layer 32, expansion of the brake hose 1 during use can be kept low. In addition, if the thermoplastic resin layer 30 is formed of any of PP, PE of EVA, high durability similar to the case of using a PET (Poly Ethylene Terephthalate) fiber can be exhibited even though the vinylon fiber is used as the strands 310 and 320.

(5) The brake hose 1, which has flex resistance, brake oil resistance and water resistance, can withstand the effects of high temperature, high pressure or ozone, etc., in addition to bending caused by operation of a steering wheel or turning of wheels in the case of being mounted on a vehicle and mechanical stress such as vibration, etc., during driving of the vehicle, and is thus suitably used as a vehicle brake hose.

### EXAMPLES

A specific embodiment of the invention will be described in detail below in reference to Examples and Comparative Examples. It should be noted that these

Examples are typical examples of a brake hose of the above-mentioned embodiment and it is obvious that the present invention is not limited to Examples and Comparative Examples.

### (1) Durability Test and Expansion Test of Rubber Hose

### Example 1

In Example 1, a vinylon fiber was used as the strands 310 and 320 and PP (melting point: 120° C.) was used as a material of the thermoplastic resin layer 30 (tape 301).

### Example 2

In Example 2, a vinylon fiber was used as the strands 310 and 320 and EVA (melting point: 100° C.) was used as a material of the thermoplastic resin layer 30 (tape 301).

### Example 3

In Example 3, a vinylon fiber was used as the strands 310 and 320 and PE (melting point: 110° C.) was used as a material of the thermoplastic resin layer 30 (tape 301).

The vulcanization temperature in the vulcanization-softening step at the time of manufacturing in Examples 1, 2 and 3 was 140° C.

### Comparative Example 1

Comparative Example 1 is a conventional brake hose having a middle rubber layer. In Comparative Example 1, a vinylon fiber was used as the strands 310 and 320 and EPDM was used as a material of the middle rubber layer which is an intermediate layer.

### Comparative Example 2

Comparative Example 2 is a conventional brake hose having a middle rubber layer in the same manner as Comparative Example 1. In Comparative Example 2, a PET fiber was used as the strands 310 and 320 and EPDM was used as a material of the middle rubber layer which is an intermediate layer.

In Examples 1, 2, 3 and Comparative Examples 1 and 2, EPDM was used as a material of the inner rubber tube 2 and that of the outer rubber tube 4. In Examples 1, 2, 3 and Comparative Examples 1 and 2, an inner diameter of the inner rubber tube 2 was 3.4 mm, an outer diameter of the inner rubber tube 2 was 4.8 mm and an outer diameter of the first braided layer 31 was 6.0 mm. In addition, in Examples 1, 2 and 3, an outer diameter of the second braided layer 32 was 7.4 mm and an outer diameter of the outer rubber tube 4 was 9.8 mm. Meanwhile, in Comparative Examples 1 and 2, an outer diameter of the intermediate layer was 6.6 mm, an outer diameter of the second braided layer 32 was 8.0 mm and an outer diameter of the outer rubber tube 4 was 10.2 mm.

In addition, in Examples 1, 2, 3 and Comparative Examples 1 and 2, a braid density of the first braided layer 31 was 3580 dtex/mm and that of the second braided layer 32 was 5170 dtex/mm.

### Test Methods and Test Results

Next, test methods and test results of the brake hose 1 in the present embodiment will be described.

Test Methods

The brake hose 1 made by the above described method was cut into a predetermined length, and a durability test and an expansion test were conducted thereon. The test procedure is as follows.

At first, a brake fluid (JISK2233) was filled in the hollow portion 20 of the brake hose 1. Following this, the brake hose 1 filled with the brake fluid was attached to a test equipment which repeatedly applies pressure to the brake hose 1 within a range of 0 MPa to 9.8 MPa. An atmospheric temperature during the test was adjusted to 100° C.

As the durability test, a bending test was conducted using a bending tester (model number: V270-2) manufactured by Sum Electro Machines Co., LTD. A bending stroke was ±40 mm and bending frequency was 1.66 Hz. The number of bends until the brake hose 1 is damaged was defined as durability, and the test was conducted by bending and simultaneously twisting the brake hose 1.

Test Results

Table 1 shows components of the brake hose 1 used for the durability and expansion tests and the test results.

TABLE 1

| | | Example | Example | Example | Comparative | Comparative |
|---|---|---|---|---|---|---|
| | | 1 | 2 | 3 | Example 1 | Example 2 |
| Component | Inner rubber | EPDM | EPDM | EPDM | EPDM | EPDM |
| | tube | | | | | |
| | First braided | Vinylon | Vinylon | Vinylon | Vinylon | PET |
| | layer | | | | | |
| | Thermoplastic | PP | EVA | PE | EPDM | EPDM |
| | resin layer or | | | | | |
| | Intermediate | | | | | |
| | layer | | | | | |
| | Second | Vinylon | Vinylon | Vinylon | Vinylon | PET |
| | braided layer | | | | | |
| | Outer rubber | EPDM | EPDM | EPDM | EPDM | EPDM |
| | tube | | | | | |
| Durability | Durability | 240 | 240 | 240 | 80 | 250 |
| test | (× 10,000 | | | | | |
| | cycles) | | | | | |
| Expansion | Expansion of | 0.140 | 0.144 | 0.144 | 0.130 | 0.166 |
| test | Rubber hose | | | | | |
| | at 10.3 MPa | | | | | |
| | (ml/305 mm) | | | | | |

As obvious from the test results, the durability in the case of using PP (Example 1), EVA (Example 2) or PE (Example 3) as a material of the thermoplastic resin layer 30 is three times higher than that in the case of using EPDM (Comparative Example 1). This revealed that use of EVA, PP or PE as the material of the thermoplastic resin layer 30 significantly improves durability.

Meanwhile, it was revealed that, in Examples 1, 2 and 3, durability was equivalent to Comparative Example 2 using a PET fiber having higher durability than vinylon and expansion was lower than Comparative Example 2.

The above results revealed that the brake hoses 1 in Examples 1, 2 and 3 have high durability equivalent to the case of using the PET fiber while maintaining low expansion as a characteristics of the vinylon fiber.

### (2) Expansion-Causing Pressure Test of Outer Rubber Tube of Rubber Hose (Brake Hose) with End Clamp

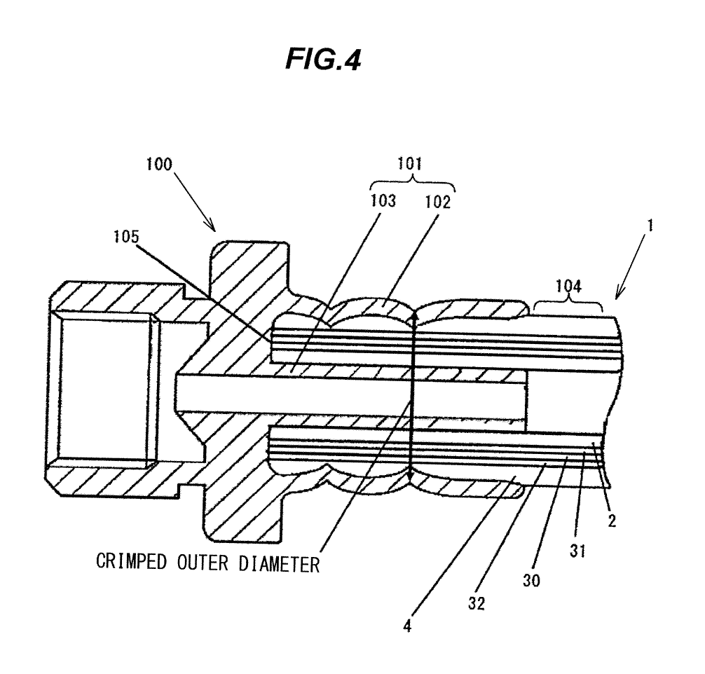

Next, an expansion-causing pressure test of the outer rubber tube 4 of the brake hose with end clamp 100 shown in FIG. 4, in which end clamps 101 are crimped at both end portions of the brake hose 1 manufactured by the above-mentioned manufacturing method, will be described. FIG. 4 is a simplified diagram illustrating a cross section of the brake hose with end clamp 100. As shown in FIG. 4, the end clamp 101 has, e.g., a cylindrical-shaped socket 102 and a nipple 103 attached to the inside of the socket 102.

### Example 4

In Example 4, the end clamp 101 are crimped at end portions of the outer rubber tube 4 of the brake hose 1 having the configuration of Example 3 so as to have a crimped outer diameter of 9.8 mm. The crimped outer diameter here is an outer diameter of the socket 102 at a most inwardly recessed position formed by crimping.

### Example 5

In Example 5, the end clamp 101 are crimped at end portions of the outer rubber tube 4 of the brake hose 1 having the configuration of Example 3 so as to have a crimped outer diameter of 9.9 mm.

### Example 6

In Example 6, the end clamp 101 are crimped at end portions of the outer rubber tube 4 of the brake hose 1 having the configuration of Example 3 so as to have a crimped outer diameter of 10.1 mm.

### Comparative Example 3

In Comparative Example 3, the end clamp 101 are crimped at end portions of the outer rubber tube 4 of the brake hose 1 having the configuration of Comparative Example 1 so as to have a crimped outer diameter of 9.8 mm.

### Comparative Example 4

In Comparative Example 4, the end clamp 101 are crimped at end portions of the outer rubber tube 4 of the brake hose 1 having the configuration of Comparative Example 1 so as to have a crimped outer diameter of 9.9 mm.

### Comparative Example 5

In Comparative Example 5, the end clamp 101 are crimped at end portions of the outer rubber tube 4 of the brake hose 1 having the configuration of Comparative Example 1 so as to have a crimped outer diameter of 10.1 mm.

Note that, the outer diameter of the brake hose 1 was 9.9 mm in all of Examples 4 to 6 and Comparative Examples 3 to 5.

Test Methods and Test Results

Next, methods and results of the expansion-causing pressure test conducted on the outer rubber tube 4 of the brake hose with end clamp 100 will be described.

Test Methods

At first, the brake hose with end clamp 100 was aged under the conditions defined in SAE J1401 (at 120° C. for 72 hours) in a state that a brake fluid (JISK2233) was filled in the hollow portion 20 of the brake hose with end clamp 100. After that, the brake fluid was drained from the hollow portion 20 and liquid such as water or brake fluid, etc., was filled in the hollow portion 20 again. Then, in this state, pressure was applied to the liquid filled in the hollow portion 20 from one of the end clamps 101 of the brake hose with end clamp 100, and pressure which causes expansion at a position 104 of the outer rubber tube 4 near the end clamp 101 was measured.

The reason why the position 104 of the outer rubber tube 4 near the end clamp 101 expands is as follows.

When the brake hose with end clamp 100 is aged, the brake fluid is likely to enter between the inner periphery of the inner rubber tube 2 and the outer periphery of the nipple of the end clamp 101. The entered brake fluid passes through a contact portion 105 between the end portion of the brake hose 1 and the end clamp 101, and reaches and enters into the second braided layer 32 located in contact with the inner periphery of the outer rubber tube 4. If high pressure is applied to the brake fluid in this state, the brake fluid is accumulated between the outer rubber tube 4 and the second braided layer 32, and the outer rubber tube 4 expands at the position 104 near the end clamp 101. When the expansion occurs, there is a possibility that the outer rubber tube 4 is ruptured at the expanded portion, which causes leakage of brake fluid.

Test Results

TABLE 2

| | Example | Example | Example | Comparative | Comparative | Comparative |
|---|---|---|---|---|---|---|
| | 4 | 5 | 6 | Example 3 | Example 4 | Example 5 |
| Crimped outer | 9.8 | 9.9 | 10.1 | 9.8 | 9.9 | 10.1 |
| diameter | | | | | | |
| (mm) | | | | | | |
| Thermoplastic | PE | PE | PE | EPDM | EPDM | EPDM |
| resin layer or | | | | | | |
| Intermediate | | | | | | |
| layer | | | | | | |
| Expansion- | 50< | 50< | 50< | 40 | 35 | 20 |
| causing | | | | | | |
| pressure | | | | | | |
| (MPa) | | | | | | |

As obvious from the test results, it was revealed that, in the case of using the thermoplastic resin layer 30 (PE), the outer rubber tube 4 does not expand at the position 104 near the end clamp 101 even when 50 MPa of pressure is applied to the liquid filled in the hollow portion 20 and the expansion-causing pressure is significantly improved as compared to the case of using the intermediate layer (EPDM). This is because, in the brake hose with end clamp 100 of the invention, the thermoplastic resin penetrated into the mesh openings 32a of the second braided layer 32 reduces entrance of the brake fluid into the second braided layer 32 even though the brake fluid reaches the second braided layer 32.

Although the embodiment and examples of the invention have been described, the invention according to claims is not to be limited to the above-mentioned embodiment and examples. Further, please note that not all combinations of the features described in the embodiment and examples are not necessary to solve the problem of the invention.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A method of manufacturing a rubber hose comprising:
an inner rubber tube having a hollow portion;
first and second braided layers formed by braiding strands; and
an outer rubber tube,
the method comprising:
forming a laminated structure by sequentially forming the first braided layer on an outer periphery of the inner rubber tube, a thermoplastic resin layer comprising a thermoplastic resin on an outer periphery of the first braided layer, the second braided layer on an outer periphery of the thermoplastic resin layer and the outer rubber tube on an outer periphery of the second braided layer;
vulcanizing the inner rubber tube and the outer rubber tube and softening the thermoplastic resin layer by heating the laminated structure to not lower than a softening temperature of the thermoplastic resin layer; and
integrating the first and second braided layers by softening the thermoplastic resin layer and then solidifying the soft thermoplastic resin penetrated into mesh openings formed between the strands.

2. The method according to claim 1, wherein the thermoplastic resin layer comprises polyethylene (PE) having a melting point of 90 to 165° C. or polyethylene-polyvinyl acetate copolymer (EVA) having a melting point of 90 to 165° C.

3. The method according to claim 1, wherein the thermoplastic resin layer comprises polypropylene (PP) having a melting point of 90 to 165° C.

4. The method according to claim 1, wherein the thermoplastic resin layer is formed by winding a strip-shaped thermoplastic resin around the outer periphery of the first braided layer.

5. The method according to claim 1, wherein the strand comprises a vinylon fiber.

6. The method according to claim 1, wherein the first braided layer has a braid density of 3500 to 4400 dtex/mm, and the second braided layer has a braid density of 2700 to 5200 dtex/mm.

7. A rubber hose, comprising:
an inner rubber tube having a hollow portion;
first and second braided layers formed by braiding strands and provided on an outer periphery of the inner rubber tube; and
an outer rubber tube provided on an outer peripheral side of the first and second braided layers,
wherein the first and second braided layers are integrated by solidifying a soft thermoplastic resin penetrated into mesh openings formed between the strands.

8. The rubber hose according to claim 7 that is adapted to be used as a brake hose for a vehicle, wherein the hollow portion of the inner rubber tube is adapted to circulate a brake fluid for operating a brake of the vehicle therethrough.

9. A rubber hose with an end clamp, comprising:
an inner rubber tube having a hollow portion;
first and second braided layers formed by braiding strands and provided on an outer periphery of the inner rubber tube;
an outer rubber tube provided on an outer peripheral side of the first and second braided layers; and
the end clamp crimped at an end portion of the outer rubber tube,
wherein the first and second braided layers are integrated by solidifying a soft thermoplastic resin penetrated into mesh openings formed between the strands.
